(19) United States
(12) Patent Application Publication
(10) Pub. No.: US 2006/0262789 A1
(43) Pub. Date: Nov. 23, 2006

(54) Method and corresponding device for packets classification

(75) Inventors: Yaron Menahem Peleg, Tel-Aviv (IL); Rann Glaser, Givatayim (IL); Tal Muskal, Tel-Aviv (IL)

Correspondence Address: Active Knowledge Ltd., POB 294, Kiryat Tivon, 36010, IL

(73) Assignee: Go Networks Inc., Mountain View, CA (US)

(21) Appl. No.: 11/436,579

(22) Filed: May 19, 2006

Related U.S. Application Data
(60) Provisional application No. 60/682,805, filed on May 20, 2005.

(51) Int. Cl. H04L 12/56

(52) U.S. Cl. 370/389; 370/401

(57) ABSTRACT

Methods and corresponding devices for packets classification featuring pattern recognition, and not content recognition or port matching. The methods and corresponding devices are able to recognize traffic in the background and/or offline, without overloading the system.

### FIELD AND BACKGROUND OF THE INVENTION

The present invention relates to packets classification and, more particularly, to methods and corresponding devices for packets classification featuring pattern recognition, and not content recognition or port matching.

Prior art classifiers classify packets according to their MAC address, and/or IP address, and/or IP ports. This classification method may be run in parallel on the MAC address, IP address, and IP ports.

Moreover, a classifier is usually implemented inside a bridge or a router.

A significant and general limitation of currently available classifiers, is that they are based on content analysis and/or identification. Therefore, most prior-art classifiers can not classify coded and/or encoded packets. In a case where there is a need to classify coded and/or encoded packets, prior-art classifiers require the use of powerful network processors. In addition, prior-art classifiers, which are based on content analysis and/or identification, overload the system when there is a large amount of traffic.

An additional significant limitation of prior art devices operating on the basis of ports identification, is that port identification is not a robust mechanism. Moreover, port identification algorithms are easy to go around, and it is not necessarily possible to know through which ports the transmissions are taking place.

An additional significant limitation of prior-art classifiers based on ports identification is the simplicity by which a data session can impersonate itself as a VoIP session and thereby transmit large amounts of high-priority data.

To date, the inventor is unaware of prior art teaching about a method and corresponding device for classifying sessions based on the pattern and/or characteristics of traffic, rather than traffic contents.

To one of ordinary skill in the art, there is thus a need, and it would be highly desirable to have a method and corresponding device for classifying sessions based on the pattern and/or characteristics of traffic rather than traffic contents.

Moreover, it is also highly desirable to have a method and corresponding classifier for highly efficient and generic VoIP classification and other relevant streaming classifications.

Moreover, with cost considerations in mind, it is also highly desirable to have a method and corresponding classifier that can be cost-effectively integrated within an embedded system.

Moreover, it is also highly desirable to have a method and corresponding classifier to be used within systems featuring very high traffic rates. An efficient classifier that does not read the data in every packet is required, even by a system having a powerful processor.

### SUMMARY OF THE INVENTION

The present invention relates to packets classification and, more particularly, to a method and corresponding device for packets classification featuring pattern recognition and not content recognition or port matching.

Implementation of the methods and corresponding devices for packets classification of the present invention involves performing or completing selected tasks or steps manually, semi-automatically, fully automatically, and/or, a combination thereof. Moreover, according to actual instrumentation and/or equipment used for implementing a particular preferred embodiment of the disclosed methods and corresponding devices, several selected steps of the present invention could be performed by hardware, by software on any operating system of any firmware, or a combination thereof. In particular, regarding hardware, selected steps of the invention could be performed by a computerized network, a computer, a computer chip, an electronic circuit, hard-wired circuitry, or a combination thereof, involving a plurality of digital and/or analog, electrical and/or electronic, components, operations, and protocols. Additionally, or alternatively, regarding software, selected steps of the invention could be performed by a data processor, such as a computing platform, executing a plurality of computer program types of software instructions or protocols using any suitable computer operating system.

### BRIEF DESCRIPTION OF THE DRAWINGS

The present invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented for the purpose of providing what is believed to be the most useful and readily understood description of the principles and conceptual aspects of the present invention. In this regard, no attempt is made to show structural details of the present invention in more detail than is necessary for a fundamental understanding of the invention. Moreover, the description taken with the drawings making apparent to those skilled in the art how the several forms of the invention may be embodied in practice. Identical structures, elements or parts which appear in more than one figure preferably are labeled with a same or similar number in all the figures in which they appear. In the drawings:

FIG. 1 is an illustration of an exemplary classifier, in accordance with the present invention; and

FIG. 2 is an illustration of an exemplary classifier, in accordance with the present invention;

### DESCRIPTION OF THE PREFERRED EMBODIMENTS

A general aspect of novelty and inventiveness of the present invention is the ability to work according to pattern recognition and not content recognition or port matching.

Another unique feature of novelty and inventiveness of the present invention is its ability to recognize traffic in the background and/or offline, without overloading the system.

The present invention is methods and corresponding devices for packets classification. The preferred embodiments of the present invention are discussed in detail below. It is to be understood that the present invention is not limited in its application to the details of the order or sequence of steps of operation or implementation of the method set forth in the following description, drawings, or examples. While specific steps, configurations and arrangements are discussed, it is to be understood that this is done for illustrative purposes only. A person skilled in the relevant art will recognize that other steps, configurations and arrangements can be used without departing from the spirit and scope of the present invention.

In an embodiment of the present invention, the sessions are VoIP sessions, and/or Multimedia over IP sessions. Moreover, it is to be understood that VoIP is only an example of a streaming application for which the present invention is useful. For the sake of simplicity, the disclosure of the present invention is illustrated using both references and examples mostly related to VoIP applications. However, it is to be understood that these are only examples of the present invention, and there is no intent of limiting the scope of the present invention to VoIP applications or to Multimedia over IP applications.

In an embodiment of the present invention, the classifier operates on the pattern or characteristics of the traffic, and not on the contents of the traffic.

In accordance with the present invention, an exemplary classifier classifies the packets based on their length and/or the time intervals between successive packets belonging to the same session.

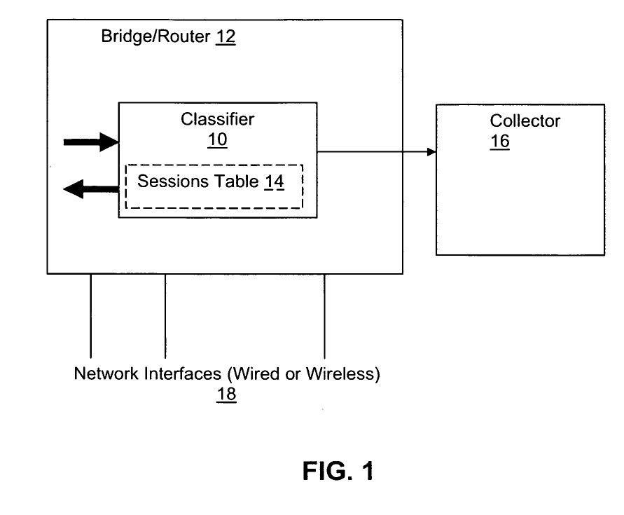

Referring now to FIG. 1, exemplary classifier 10 is located within a network bridge or a network router 12. Classifier 10 maintains a sessions table 14. classifier 10, upon receiving packets for classification from the network interfaces, sends them to a collector.

Each primary step, and additional steps, needed for enabling the use of this packets classifier are described in the following detailed description.

Identifying at least one unidirectional session.

In an embodiment of the present invention, a unidirectional session is identified by one or more criterions. It is to be understood that the following criterions may be operated in every possible combination, and dynamically, according to the state of the network and type of data.

Seven exemplary criteria, useful for the classifier of the present invention, are described below.

(a) IP Address & MAC Address.

Referring now to the IP address & MAC address criterion, according to an optional identification embodiment, each packet passing through the network interfaces is checked if the address of the packet matches the relevant IP address or MAC address. If the address of the packet does not match the relevant IP address or MAC address, nothing is done, i.e. the packet is not tagged and the Spectrum Management algorithm is not updated. Moreover, the packet is not tagged and therefore does not identified as a packet that should be treated specially. For example, different QoS.

(b) Application Port Number

For example, port ‘x’ receives predefined QoS; port ‘y’ is classified as a specific type (c) Length of the Packet.

Referring now to the length of the packet criterion, there is checking whether or not the length of the packet meets the length-range requirements. If the length of the packet meets the length-range requirements, the appropriate IP source and IP destination, plus optional additional information (such as source and destination port number), are looked for in a sessions table. It is to be noted that the length can be a range, i.e. as long as the packet is in the length, it can be classified.

(d) Type of Service (TOS) in the IP Level.

Referring now to the Type of Service (TOS) in the IP-level criterion, there are applications that identify themselves. For example, an application may identify itself as voice over IP or video over IP. In either case, it is possible to use this identifying information for classifying the transmission in accordance with the present invention.

(e) QoS in the MAC Level.

Referring now to the QoS (IEEE 802.1Q/p class of service (COS) bits) in the MAC level, there are standards that specifically define the QoS in OSI layer two. In this case, it is possible to use the abovementioned application's self-identification information for classifying the transmission in accordance with the present invention.

(f) Time Interval Between Packets

Referring now to the time interval between packets criterion, there are session types featuring a predefined time interval between packets. When this is the case, identifying a session featuring the required of time interval between packets may indicate that this is a type of session the classifier of the present invention is looking for. Here too, the required time interval can be a range.

(g) Throughput Per Second.

Referring now to the throughput per second criterion, there are types of sessions featuring a predefined throughput per second. When this is the case, identifying a session featuring the throughput per second may indicate that this is a type of session the classifier is looking for. Moreover, the throughput per second may be derived from the length and intervals between the packets. Alternatively, the throughput per second may be separately measured.

Moreover, in an alternative embodiment, there is looking for the appropriate IP source, IP destination, and port numbers, in a sessions table. In an embodiment of the present invention, the sessions table stores the identified and potential sessions. In case there is no entry for the specific session in the sessions table, a new entry in the sessions table is created. Actually, the new entry represents a new potential session.

Combinations. All combinations are possible. typical, length and time interval combination for example, statistical classifying is useful for cases where it is not possible to get into the data and/or protocol, such as encrypted information/encrypted tunnel. by using the statistical method, it is possoble to classify the information. if there are a few sessions in parallel, and it's encripted tunnel, it is possible to identify the various sessions. separate the sessions enable the system to give different QoS to different session, such as VoIP and data.

According the statistics, it is possible to identify the streaming type, vocoder type, how much delay is allowed, packatization. size, and use of VAD (voice activity detection). Those are useful for decisions of load balancing, spectrum management, and session restrictions.

Usually, the classifier identifies the sessions/packets. This information is usually used to apply the correct QoS to this session/packet.

For every session in the sessions table, an aging mechanism is used for cleaning up the sessions table at required events and/or times.

Alternatively, there is overwriting the oldest inactive session records with new records, when needed.

The classifier has to decide when there is a session according to several consecutive packates that matches its rules. The classifier may identify that is it not the same session according a few consecutive packets and their time. i.e. the classifier has to be able to know when there is a streaming session and when the streaming session ends.

Optionally, searching for a matched session in the opposite direction.

Optionally, after identifying a unidirectional session, a matched session in the opposite direction is sought. The matching is based on reversed source and reversed destination IP-addresses.

Tagging the Identified Packets.

Following the classification operation, it is possible to classify some or all of the packets according to the session they belong to. By classifying the packets according to their correlative session, it is possible to tag the classified packets. The tag describes the required QoS appropriate for the session.

In an embodiment of the present invention, a Spectrum Management algorithm is applied for frequency-allocation optimizations and stations-allocation optimizations. In these cases, the Spectrum Management algorithm is updated with the profile of the specified station. According to the profile of the specified station, the Spectrum Management algorithm decides what to do with the specific station.

In an embodiment of the present invention, the Spectrum Management algorithm may take into account the throughput and/or latency. For purposes of the present invention, latency is defined as the average time between the desired transmission time and the actual transmission time.

the information from the classifier can be used by LB, SM, network management, etc. that has to know the type of traffic, performance . . .

In another particular embodiment of the general method and corresponding device for packets classification of the present invention, there is prioritizing users and prioritizing equipment. For example, the equipment may be a VoIP phone.

In another particular embodiment of the general method and corresponding device for packets classification of the present invention, there is identifying peer-to-peer (P2P) traffic. Moreover, the P2P traffic may be tagged as low priority

In another particular embodiment of the general method and corresponding device for packets classification of the present invention, there is applying to the packets at least one of the following methods: encryption, tunneled linking, IP tunneling, or UDP tunneling. Although each of the abovementioned protocols feature different headers, the method of the present invention makes it possible to identify all of them.

In another particular embodiment of the general method and corresponding device for packets classification of the present invention, the QoS may later be used as an input for QoS protocol, including 802.11e or 802.1q, or any similar QoS protocol.

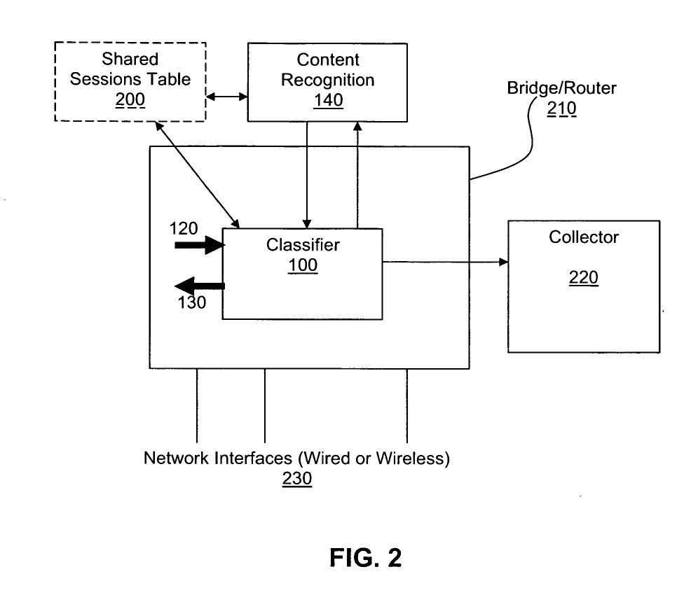

Steps, components, operations, and implementation of the method and corresponding device for packets classification, according to the present invention are better understood with reference to FIG. 2.

According to another embodiment of the present invention, there is adding a content recognition technology to the above described method for packets classification featuring pattern classification. There are known in the art tools that, when connected to a network, analyze the type of data passing through the network according to the data in the packets themselves. Integrating content recognition technology into the system makes it possible to identify additional traffic types, and to increase the reliability of the identification process.

In an embodiment of the present invention, the content recognition technology works in the background. A general aspect of novelty and inventiveness of the present invention is the fact that operating content recognition technology in the background does not overload the system.

FIG. 2 illustrates an embodiment wherein a classifier is located within a network bridge or a network router. The classifier may maintain a shared sessions table accessible to content recognition technology device 140 that is also connected to the classifier. The classifier receives the packets for classification from the network interfaces and sends them to a collector. Moreover, the classifier receives raw data 120 and forwards tagged data 130.

Each primary step, and additional steps, needed for enabling the use of this method and corresponding device for packets classification are described in the following detailed description.

Forwarding each packet through the classifier of the present invention.

As known in the art, sessions, by definition, are unidirectional, and therefore each packet should belong to one unidirectional session.

Checking if the current session appears in the sessions table.

In an embodiment of the present invention, the classifier is checking if the current session appears in the sessions table. If the current session does not appear in the sessions table, the classifier finds an entry in the sessions table, wherein a new entry is created, and a copy of the packet is directed asynchronically to the content recognition technology. According to this optional implementation, the content recognition technology does not delay the traffic because it is offline, and is not located within the data flow.

Tagging the Session.

Referring now to the shared sessions table, in an embodiment of the present invention, each table entry contains the following: Source IP address, Destination IP address, Source Port number, and Destination Port number.

Optionally, there is a type identifier for each session. In addition or alternatively, the session is tagged.

Optionally, the default value for a session is unidentified.

Identifying the Packet.

The content recognition technology identifies the packet. In an embodiment of the present invention, the packet identification occurs offline, thus enabling the use of non real-time content recognition technology/classifiers.

Optionally, the packet can be send to the bridge, plus copied (re delayed) to an offline classier. the classifier examine the packet, add it to a session table, which will be used for classifying the session. this is done in cinsecutive pacletsa until the offline classifier detect the type of the specific session, the classifier takes the identifiers of that session, that are used by the session table. from that point, the session table is used for classifying the real time traffic.

An example of an open-source content recognition technology is Ethereal.

Tagging the session in the shared sessions table.

If the session was identified by the content recognition technology as a VoIP session or video session, the content recognition technology tags the session in the shared sessions table.

Optionally, if the session is a signaling session, the content recognition technology tags the appropriate entry in the shared sessions table as a signaling session. “Signaling session” indicates that the classifier should continue directing a copy of the packets to the content recognition technology until a predefined timeout occurs. The object of tagging the signaling session is to identify the VoIP session derived from this signaling session.

In a case wherein the content recognition technology identifies the protocol as being one of its database-stored predefined protocols, and furthermore, that it is not any of the following: VoIP, Video, signaling, or one of the predefined streaming sessions, the content recognition technology tags the session to stop the classifier from passing anymore packets belonging to this specific session, to the collector.

In a case wherein after a predefined number of packets have been sent to the collector and the content recognition technology does not identify the session, the session is tagged by the content recognition technology tags, in order to stop the classifier from passing any more packets belonging to the specific session.

Optionally, searching for a matched session in the shared sessions table.

Optionally, after a unidirectional session is identified, a matched session in the opposite direction is sought. This matching is based on reversed source and reversed destination IP addresses.

In an embodiment of the present invention, following the classification, the packets are tagged wherein the tag describes the QoS of the packet.

In another embodiment of the present invention, a Spectrum Management algorithm updates the user's profile in parallel to all other steps.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

It is to be understood that the present invention is not limited in its application to the details of the order or sequence of steps of operation or implementation, nor to the details of construction, arrangement, and, composition of the corresponding thereof, set in the description, drawings, or examples of the present invention.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described in conjunction with specific embodiments and examples thereof, it is to be understood that they have been presented by way of example, and not limitation. Moreover, it is evident that many alternatives, modifications and variations will be apparent to those skilled in the art. Accordingly, it is intended to embrace all such alternatives, modifications and variations that fall within the spirit and broad scope of the appended claims and their equivalents.

What is claimed is:

1. A method for classifying packets comprising:
(a) identifying at least one unidirectional session, and
(b) tagging the identified packets.

2. The method of claim 1, further comprising searching for a matched session in the opposite direction.

3. The method of claim 1, wherein said identifying comprising the determining at least one of the following criteria:
(a) IP address & MAC address,
(b) application port number,
(c) length of the packet,
(d) type of Service in the IP level,
(e) QoS in the MAC level,
(f) time interval between packets, or
(g) throughput per second.
